(19) United States
(12) Patent Application Publication
(10) Pub. No.: US 2007/0030411 A1
(43) Pub. Date: Feb. 8, 2007

(54) Liquid crystal display panel having a diffusion polarizer and liquid crystal display device using same

(75) Inventor: Li-Chun Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/501,320

(22) Filed: Aug. 8, 2006

(30) Foreign Application Priority Data
Aug. 8, 2005 (TW) 94126745

(51) Int. Cl. G02F 1/1333

(52) U.S. Cl. 349/58; 349/64

(57) ABSTRACT

An exemplary LCD panel (210) includes a first substrate (211) and a second substrate (213) disposed opposite to each other and spaced apart a predetermined distance, a liquid crystal layer (212) between the first and second substrates, a polarizer (214) disposed at an outer surface of the first substrate; and a diffusion polarizer (215) disposed on an outer surface of the second substrate. The diffusion polarizer includes a polarizing sheet (216) and a diffusion sheet (217). With these configurations, when the LCD panel is employed in an LCD device, the second substrate can availably protect and prevent the diffusion sheet from being bent during assembled process.

### FIELD OF THE INVENTION

The present invention relates to display devices, and more particularly to a liquid crystal display (LCD) device having an LCD panel with a diffusion polarizer.

### GENERAL BACKGROUND

Liquid crystal displays are commonly used as display devices for compact electronic apparatuses, because they are not only very thin but also provide good quality images with little power consumption.

As shown in FIG. 3, a typical LCD device 100 includes an LCD panel 110, a backlight module 120, and a frame 130 accommodating the LCD panel 110 and the backlight module 120. The backlight module 120 includes a first diffusion sheet 121, a first prism sheet 122, a second prism sheet 123, a second diffusion sheet 124, a plurality of lamps 126, and a reflective plate 127, generally disposed in that order from top to bottom.

Each of the diffusion sheets 121 and 124 and the prism sheets 122 and 123 is typically configured as a multilayer structure. The first diffusion sheet 121 is used for ensuring that light output therefrom is such that the backlight module 120 effectively functions as a uniform surface light source. However, the first diffusion sheet 121 is liable to be bent during the process of assembly of the backlight module 120. When this happens, traces may be formed in the first diffusion sheet 121. If the first diffusion sheet 121 has traces, the backlight module 120 may be unable to effectively function as a uniform surface light source, in which case the optical performance of the LCD device 100 is impaired.

What is needed, therefore, is an LCD panel and an LCD device that can overcome the above-described deficiencies.

### SUMMARY

An exemplary LCD panel includes a first substrate and a second substrate disposed opposite to each other and spaced apart a predetermined distance, a liquid crystal layer between the first and second substrates, a polarizer disposed at an outer surface of the first substrate, and a diffusion polarizer disposed on an outer surface of the second substrate. The diffusion polarizer includes a polarizing sheet and a diffusion sheet.

An exemplary LCD device includes an LCD panel and a backlight module arranged under the LCD panel for illuminating it. The liquid crystal display panel includes a first substrate and a second substrate disposed opposite to each other and spaced apart a predetermined distance, a liquid crystal layer between the first and second substrates, a polarizer disposed at an outer surface of the first substrate, and a diffusion polarizer disposed on an outer surface of the second substrate. The diffusion polarizer includes a polarizing sheet and a diffusion sheet.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side view of an LCD panel according to an exemplary embodiment of the present invention.

FIG. 2 is an exploded, side view of an LCD device employing the LCD panel of FIG. 1.

FIG. 3 is an exploded, side view of a conventional LCD device.

### DETAILED DESCRIPTION OF PREFERRED EMBODIMENTS

Reference will now be made to the drawings to describe the preferred embodiments in detail.

FIG. 1 is a schematic, side view of an LCD panel according to an exemplary embodiment of the present invention. The LCD panel 210 includes a first substrate 211, a second substrate 213, a liquid crystal layer 212, a polarizer 214, and a diffusion polarizer 215.

The first substrate 211 and the second substrate 213 are disposed opposite to each other and spaced apart a predetermined distance. The liquid crystal layer 212 is interposed between the first and second substrates 211, 213. The polarizer 214 is disposed on an outer surface (not labeled) of the first substrate 211, and the diffusion polarizer 215 is disposed on an outer surface (not labeled) of the second substrate 213.

The diffusion polarizer 215 includes a polarizing sheet 216 adjacent to the second substrate 213, and a diffusion sheet 217 adhered to the polarizing sheet 216 by a transparent adhesive substance. The diffusion sheet 217 includes a base layer 219 and a diffusion layer 218. The diffusion layer 218 includes a plurality of diffusion particles (not shown) therein for diffusing light beams. The base layer 219 is made of crystallizable thermal plastic material, and is used for supporting and protecting the diffusion layer 218.

The diffusion sheet 217 is tightly adhered to the polarizing sheet 216 via the transparent adhesive substance to form the diffusion polarizer 215, which is attached on the outer surface of the second substrate 213. The second substrate 213 is rigid, and provides ample protection for preventing the diffusion sheet 217 from being bent during the process of assembly of the LCD panel 210.

The first substrate 211 further includes a color filter layer (not labeled) attached on an inner surface thereof. The second substrate 213 further includes a thin film transistor layer (not labeled) attached on an inner surface thereof. That is, the liquid crystal layer 212 is interposed between the color filter layer and the thin film transistor layer.

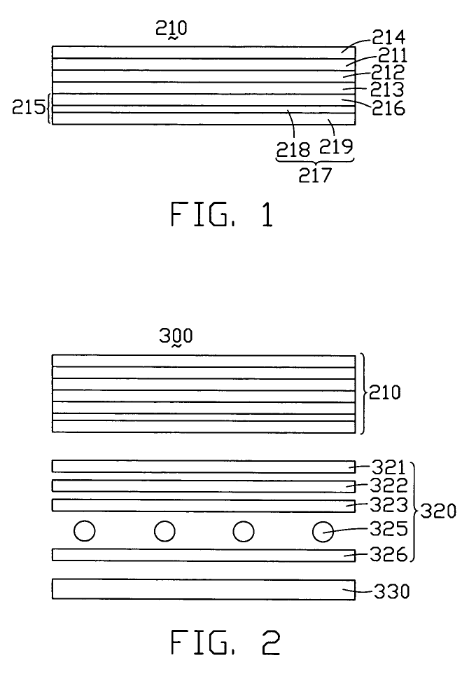

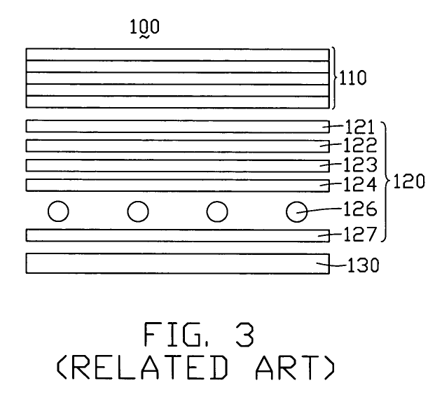

FIG. 2 is a side view of an LCD device employing the LCD panel 210. The LCD device 300 includes the LCD panel 210, a backlight module 320 disposed under the LCD panel 210 for illuminating it, and a frame 330 for accommodating the LCD panel 210 and the backlight module 320.

The backlight module 320 includes a first prism sheet 321, a second prism sheet 322, a diffusion sheet 323, a plurality of lamps 325, and a reflective plate 326, arranged generally in that order from top to bottom.

In operation, some of light beams (not shown) emitted by the lamps 325 directly transmit to the diffusion sheet 323. Other light beams emitted by the lamps 325 transmit to the diffusion sheet 323 after being reflected by the reflective plate 326. All the light beams then pass through the diffusion sheet 323, the second and first prism sheets 322, 321, and the diffusion sheet 217 of the diffusion polarizer 215 to illuminate the liquid crystal layer 212 of the LCD panel 210.

In summary, when the LCD panel 210 is employed in the LCD device 300, the second substrate 213 can amply protect the diffusion sheet 217 and prevent the diffusion sheet 217 from being bent during the process of assembly of the LCD device 300.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display panel, comprising:
a first substrate and a second substrate disposed opposite to each other and spaced apart a predetermined distance;
a liquid crystal layer between the first and second substrates;
a polarizer disposed at an outer surface of the first substrate; and
a diffusion polarizer disposed on an outer surface of the second substrate,
wherein the diffusion polarizer comprises a polarizing sheet and a diffusion sheet.

2. The liquid crystal display panel as claimed in claim 1, further comprising a transparent adhesive substance adhering the diffusion sheet and the polarizing sheet together.

3. The liquid crystal display panel as claimed in claim 1, wherein the diffusion sheet comprises a base layer and a diffusion layer.

4. The liquid crystal display panel as claimed in claim 3, wherein the diffusion layer comprises a plurality of diffusion particles.

5. The liquid crystal display panel as claimed in claim 3, wherein the base layer is made of crystallizable thermal plastic material.

6. The liquid crystal display panel as claimed in claim 1, further comprising a color filter layer and a thin film transistor layer provided at the first and second substrates, respectively.

7. The liquid crystal display panel as claimed in claim 6, wherein the liquid crystal layer is between the color filter layer and the thin film transistor layer.

8. A liquid crystal display device, comprising:
a liquid crystal display panel; and
a backlight module arranged under the liquid crystal display panel for illuminating it;
wherein the liquid crystal display panel comprises:
a first substrate and a second substrate disposed opposite to each other and spaced apart a predetermined distance;
a liquid crystal layer between the first and second substrates;
a polarizer disposed at an outer surface of the first substrate; and
a diffusion polarizer disposed on an outer surface of the second substrate,
wherein the diffusion polarizer comprises a polarizing sheet and a diffusion sheet.

9. The liquid crystal display device as claimed in claim 8, further comprising a frame accommodating the liquid crystal display panel and the backlight module.

10. The liquid crystal display device as claimed in claim 8, wherein the liquid crystal display panel further comprises a transparent adhesive substance adhering the diffusion sheet and the polarizing sheet together.

11. The liquid crystal display device as claimed in claim 8, wherein the diffusion sheet comprises a base layer and a diffusion layer.

12. The liquid crystal display panel as claimed in claim 11, wherein the diffusion layer comprises a plurality of diffusion particles.

13. The liquid crystal display panel as claimed in claim 11, wherein the base layer is made of crystallizable thermal plastic material.

14. A liquid crystal display panel, comprising:
a first substrate and a second substrate disposed opposite to each other and spaced apart a predetermined distance;
a liquid crystal layer between the first and second substrates; and
a diffusion polarizer disposed on an outer surface of the second substrate, wherein the diffusion polarizer comprises a polarizing sheet and a diffusion sheet.
